(19) United States
(12) Patent Application Publication
(10) Pub. No.: US 2010/0245034 A1
(43) Pub. Date: Sep. 30, 2010

(54) METHOD OF READING MRZ USING SAM FOR ELECTRONIC CHIP BASED TRAVEL DOCUMENT OR IDENTIFICATION DOCUMENT

(75) Inventors: Lyndon Irwin D'Oliveiro, Selangor (MY); Tuck Keong Ho, Selangor (MY)

Correspondence Address: Fleit Gibbons Gutman Bongini & Bianco PL, 21355 EAST DIXIE HIGHWAY, SUITE 115, MIAMI, FL, 33180, US

(73) Assignee: IRIS CORPORATION BERHAD, Bukit Jalil, Kuala Lumpur (MY)

(21) Appl. No.: 12/301,850

(22) PCT Filed: Jun. 28, 2007
(86) PCT No.: PCT/MY2007/000044

§ 371 Date: Nov. 21, 2008

(51) Int. Cl. G05B 19/00

(52) U.S. Cl. 340/5.6

(57) ABSTRACT

Basic Access Control (BAC), as described in the ICAO specifications for machine readable travel documents, requires Basic Access Keys to establish a BAC session. Up to now, the information used to generate these keys has been optically scanned from the Machine Readable Zone (MRZ) of the document data page. This invention allows the Basic Access Control feature to be implemented securely without visually/optically scanning the data page of the MRTD.

### FIELD OF INVENTION

The invention relates to Basic Access Control (BAC), as described in the international Civil Aviation Organization (ICAO) specifications for machine readable travel documents, which requires Basic Access Keys to establish a BAC session. ICAO specifications are located in Doc 9303 Machine Readable Travel Documents Part 1 Machine Readable Passports Volume 2 Specifications for Electronically Enabled Passports with Biometric Identification Capability. Up to now, the information used to generate these keys has been optically scanned from the Machine Readable Zone (MRZ) of the document data page. This invention allows the Basic Access Control feature to be implemented securely without visually/optically scanning the data page of the Machine Readable Travel Document (MRTD).

### BACKGROUND ART

With the introduction of electronic passports and travel document according to specifications of the International Civil Aviation Organization (reading ICAO), privacy concerns were raised that the chip in the passport or travel document could be read surreptitiously from a distance; either by interrogating a closed book carried by an unsuspecting traveler (skimming) or by listening in on a pre-established communication session (eavesdropping) between a legitimate reader (such as at border crossing points) and the MRTD chip.

in anticipation of such attacks, ICAO recommended a security mechanism known as Basic Access Control (reading BAC) that protects the electronic chip from skimming and eavesdropping. It protects from skimming by securing read access of the chip with a digital key (Message Authentication Code). Protection from eavesdropping is achieved by encrypting the communications between chip and reader with another key (Encryption Key). The information to derive these keys is printed inside the book in the MRZ and is based on the 3 fields commonly found in every passport (Document Number, Date of Birth and Date of Document Expiry). The premise behind this mechanism is that unauthorised parties typically do not have access to an open book; their skimming/eavesdropping attempts are usually carried out without the document holder's knowledge or permission. Conversely, those allowed to open the book (usually authorised immigration officers) should be allowed access to the relevant information without much inconvenience.

The conventional method of obtaining the MRZ data is by optically scanning the designated area. The retrieved data is subjected to an Optical Character Recognition (reading OCR) algorithm for reduction of the image to text. Alternatively, the same information can be obtained through a human reading of the OCR font.

When a MRTD with BAC mechanism is presented to an inspection system, the MRZ is optically scanned to retrieve the Document Number, Date of Birth and Date of Expiry including their respective check digits. The Basic Access Keys, namely the seed key (K_{SEED}), encryption key (K_{ENC}) and message authentication code (K_{MAC}) are derived from these fields via a process of concatenation, hashing and parity adjustment. These Basic Access Keys are then used by the MRTD chip and the inspection system for mutual authentication and derivation of session keys. Following successful authentication, subsequent communication is protected by Secure Messaging.

The optical scan process requires that the book be opened to the correct page and positioned appropriately for a sufficient amount of time without moving the book. This places several demands on the man-on-the-street who may inadvertently fail one or more of these conditions. For this reason, an alternative was created to simplify the reading of the chip without the need for an optical/visual scan. At the same time, it would not compromise the security afforded by BAC.

### SUMMARY OF THE INVENTION

The present invention provides an alternative method for storing and accessing the MRZ information required for BAC. Instead of optically scanning the data page of the MRTD, the information is read from the MRTD chip. Access to this information is protected by an additional chip, known as a Secure Access Module (SAM). A successful mutual authentication of the MRTD chip and the SAM is required before the MRZ information can be read from the MRTD chip. Following the retrieval of the MRZ information, the two methods converge along a common path.

### BRIEF DESCRIPTION OF DRAWINGS

FIG. 1 Shared processes of the optical scan and SAM-based BAC

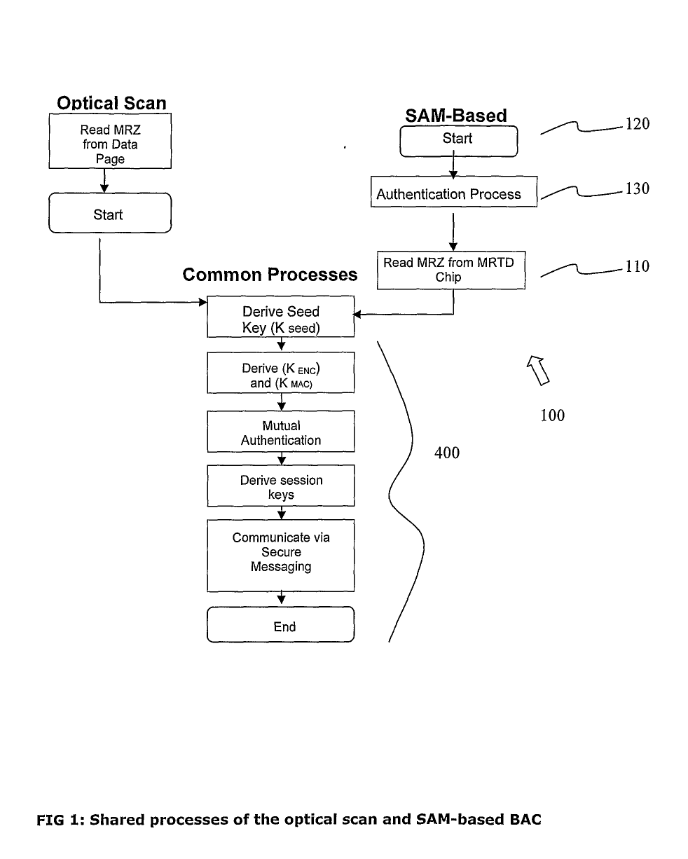

FIG. 2 Files hierarchy in MRTD chip

### DETAILED DESCRIPTION OF THE PREFERRED EMBODIMENTS

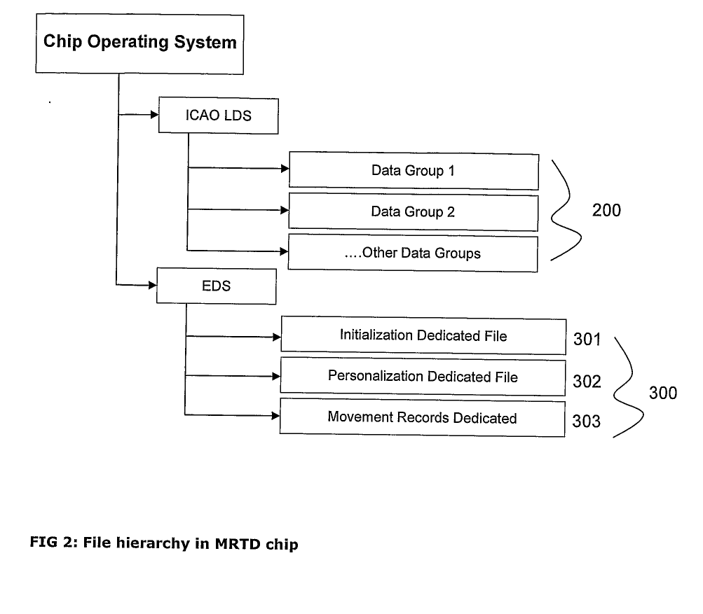

The preferred embodiment using SAM-Based 100, comprising an alternative pathway for the Basic Access Control (BAC), wherein the alternative pathway flow in 130 Authentication Process, thereafter 110 Read MRZ, from the MRTD chip. This alternative pathway of Basic Access Control enables the document holder to safeguard against skimming and eavesdropping during electronic data transfer. During the optical scan BAC, unauthorized access to chip data is prevented by concealing the MRZ within a closed book. In this invention of SAM-based BAC, using readers or devices having possession of the SAM and knowledge of the mutual authentication mechanism will be able to retrieve the MRZ. This mechanism has several advantages. The advantages are to enable the reading of chips direct from books with damaged or unreadable MRZs. Frequently, the unreadable MRZ, information may be due to the weakness of MRZ scanner, low print quality or heavy scratches of MRZs. Another advantage is to enable mobile devices to assist border inspection process of local passports by circumventing the need to swipe the MRZ with an optical scanner, the SAM-based mechanism is to be seen as complementing the inspection process, wherein unauthorized access is effectively prevented. This invention provide can provide alternative pathways without compromising security by using a SAM or SAMs, furthermore is capable to deploy to any trusted and secure systems owned by the issuing authority. The invention process starts with reading the MRZ data obtained from the printed page using either an optical scan or performing a human reading of the MRZ text, this data is used to initialize the SAM-based process beginning 120, wherein the MRTD and the SAM mutually authenticate 130, after the authentication process has been established with the Secure Data Module (SDM) components which was build as part of 130, the necessary permissions to allow access the MRZ data 110, wherein stored on the Personalization Data file 200, 300 in FIG. 2, this data is than received by the application software for further processing, the subsequent processes 400 follow existing ICAO requirements; the present invention provides an alternative pathway using SAM-based BAC compared with the existing method using optical scan, the process thereafter 110 flows to 400 sequence wherein follow the common processes. This embodiment of the invention further provides two alternative applications within the MRTD chip. The first application conforms to the ICAO LDS specifications on MRTDs 200 in FIG. 2. The second application known as EDS 300 refers to FIG. 2, which provides the data storage and security functionality for SAM-based BAC. Data storage within the EDS is partitioned into 3 Dedicated files 301,302,303 as shown in FIG. 2. Each file is accessed for different purposes in the various stages of the MRTD lifecycle, 301 Initialization Dedicated file, storage of data obtained during the Initialization Process such as the document number, 302 Personalization Dedicated File, storage of data obtained during the Personalization Process such as the MRZ, 303 Movement Records Dedicated File Data. Storage of data obtained generated at Border Control such as movement records, The EDS application 300 is secured by a scheme of SAMs, the possession of a particular SAM confers read/write permissions on a particular subset of Dedicated File(s) is shown in table 1, these read/write permissions are the minimum set of privileges required for that stage to succeed, for example, the Personalization process requires read access to Initialization Data 301 as well as read and write access to Personalization Data 302 and Movement Records Data 303. This is equivalent to five out of the total permissions available corresponding to the five checkmarks shown in the Table 1 below under the “Personalization Process” column.

TABLE 1
Processes and their permissions managed by SAMs (✓ =
allowed, x = not allowed)

| | Process | | | | | |
|---|---|---|---|---|---|---|
| | Initialization | | Personalization | | Border Inspection | |
| | (Requires Init | | (Requires Perso | | (Requires Border | |
| | SAM) | | SAM) | | Inspection SAM) | |
| | Permissions conferred by SAM | | | | | |
| Dedicated File | Read | Write | Read | Write | Read | Write |
| Initialization | ✓ | ✓ | ✓ | x | x | x |
| Data | | | | | | |
| Personalization | x | x | ✓ | ✓ | ✓ | x |
| Data | | | | | | |
| Movement Record | x | ✓ | ✓ | ✓ | ✓ | ✓ |
| Data | | | | | | |

While the invention has been particularly shown and described with reference to preferred embodiments thereof, it will be understood by those skilled in the art that the foregoing and other changes in form and details may be made therein without departing from the scope of the invention.

What is claimed is:

1. A plurality of pathways for securely accessing personalized data store in a plurality type of electronic chip based travel or identification documents.

2. The pathway claim in 1; wherein provides an alternative secure access method other than optical scan or visual.

3. The pathway claim in 1; wherein using a secure electronic authentication method to retrieve MRZ data.

4. The pathway claim in 1; wherein using one or plurality of Secure Access Modules (SAM) or Secure Data Module (SDM) both being interrogatable and non-interrogatable.

5. The pathway claim in 4; wherein attached to a RFID device/reader to facilitate the authentication process and securely communicate with the electronic chip.

6. The pathway claim in 4; wherein comprise one or plurality sets of access permissions or predefined instruction sets to enable the secure data reading and writing of data to the electronic chip.

7. The pathway claim in 1; wherein allows secure retrieval of MRZ information from the electronic chip to transfer to the subsequent BAC process.
